(19) United States
(12) Patent Application Publication
(10) Pub. No.: US 2025/0371202 A1
(43) Pub. Date: Dec. 4, 2025

(54) METHODS AND SYSTEMS FOR DETECTING SECURITY EVENTS

(71) Applicant: COMCAST CABLE COMMUNICATIONS, LLC, Philadelphia, PA (US)

(72) Inventors: David YORKEY, Wilmington, DE (US); Mark BIZUGA, Bear, DE (US)

(21) Appl. No.: 18/676,956

(22) Filed: May 29, 2024

(51) Int. Cl. G06F 21/86

(52) U.S. Cl. CPC G06F 21/86

(57) ABSTRACT

Methods and systems for security event detection are disclosed. A device may determine that it is not receiving power from a power line circuit located external to the device. The device may comprise at least one contact configured to connect to the power line circuit. Based on applying a first signal via the at least one contact, a reactance associated with the at least one contact may be determined. A cause for the device not receiving power from the power line circuit may be determined based on the reactance.

### BACKGROUND

A device may be equipped with a tamper sensor. The tamper sensor may indicate whether a security event has occurred (e.g., the device has been tampered with). Emergency services may be dispatched to respond to the security event. However, the tamper sensor may cause false positives. Emergency services may be unnecessarily dispatched in response to these false positives. This disclosure addresses these and other shortcomings.

### SUMMARY

Systems and methods for detecting security events are described herein. A device, such as a plug-in security device, may be plugged into a power line circuit to receive power for normal operation. The device may be equipped with a tamper sensor. If the device determines that it has stopped receiving power, the tamper sensor may be configured to determine why the device has stopped receiving power. For example, the tamper sensor may be configured to determine if the device has stopped receiving power because the device has been unplugged. If the tamper sensor determines that the loss of power is the result of the device being unplugged, the tamper sensor may determine that a security event has occurred. A notification indicative of the security event may be sent to emergency services. Conversely, if the tamper sensor determines that the device is still plugged in, the tamper sensor may determine that a security event has not caused the device to stop receiving power. For example, the loss of power may instead be the result of a power outage. If the tamper sensor determines that a security event has not caused the device to stop receiving power (e.g., the tamper sensor determines that the device is still plugged into the power line circuit), no notification is sent to emergency services, thereby preventing the unnecessary dispatch of emergency services.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is an example system.

FIG. 2 is an example system.

FIG. 3 is an example system.

FIG. 4 is example circuit.

FIG. 5 is an example system.

FIG. 6 is an example process.

FIG. 7 is an example method.

FIG. 8 is an example method.

FIG. 9 is an example method.

FIG. 10 is an example computing device.

### DETAILED DESCRIPTION

A device, such as a plug-in security device, may be plugged into a power line circuit at a premises for which the device provides some form of security. The device may be equipped with a tamper sensor. The tamper sensor may comprise a mechanical switch that extends from the back of the device facing a power outlet. If the device is plugged into the power outlet, the switch may be depressed. If the switch is not depressed, this may indicate that a security event has occurred (e.g., the device has been unplugged from the power outlet). Emergency services may be dispatched to respond to the security event.

However, the switch may cause false positives. For example, the device may be bumped, causing the switch to no longer be depressed, even though the device is still plugged into the power line circuit at the premises. Emergency services may be unnecessarily dispatched in response to these false positives. It may be difficult to properly align the switch with various different outlet cover plates. Further, to comply with the requirements of various regulatory agencies, the switch may need to be made of expensive corrosion resistant materials and/or be sealed. Even tamper sensors that do not rely on a mechanical switch may have drawbacks. For example, tamper sensors that rely on optical sensors may malfunction if dust accumulates on the optical sensors. Further, tamper sensors that rely on ultrasonic sensors and/or capacitive sensors may have high power demands that are not suitable for security devices that need a 24-hour battery backup. Thus, improved techniques for security event detection are desirable.

Described herein is a tamper sensor that may be integrated into a device. The device may comprise electrical contacts. The electrical contacts may be plugged into a power outlet to receive power from a power line circuit. If the device determines that it has stopped receiving power from the power line circuit, instead of automatically triggering a security event, the tamper sensor may determine why the device has stopped receiving power from the power line circuit. To determine why the device has stopped receiving power from the power line circuit, the tamper sensor may determine a reactance associated with the electrical contacts of the device. If the reactance satisfies (e.g., is greater than or equal to) a threshold, the tamper sensor may determine that the device is still plugged into the power outlet and that a power outage has caused the device to stop receiving power from the power line circuit. If the reactance does not satisfy (e.g., is less than) the threshold, the tamper sensor may determine that the device has stopped receiving power from the power line circuit because the device has been unplugged from the power outlet. If the tamper sensor determines that the device has stopped receiving power because it has been unplugged, the device, using backup power (e.g. from a battery) for example, may be configured to send a notification that a security event has occurred.

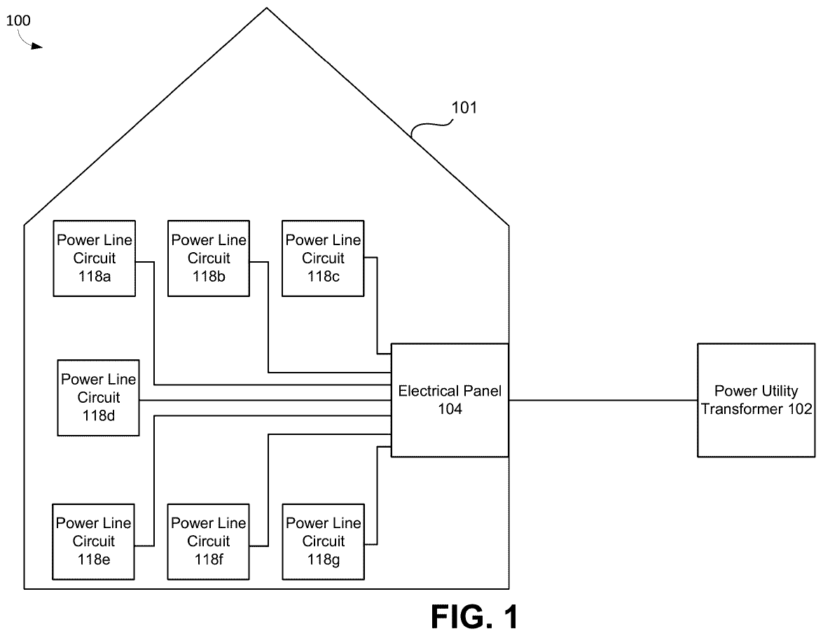

FIG. 1 is an example system 100. The system 100 may comprise a power utility transformer 102, an electrical panel 104, and a plurality of power line circuits 118a-g. The electrical panel 104 (e.g., breaker box) and the plurality of power line circuits 118a-g may be located at a premises 101. The premises 101 may comprise a property, dwelling, terminal, building, floor, and/or the like. The premises 101 may comprise different rooms, walls, door, windows, and/or the like. Electrical power, such as AC power, may be provided from the power utility transformer 102 to the electrical panel 104 located at the premises 101. The electrical panel 104 may provide electrical power, such as AC power, to each of the plurality of power line circuits 118a-g located at the premises. Each of the plurality of power line circuits 118a-g may provide power to all of the power outlets in a particular area or room of the premises 101. For example, the power line circuit 118a may provide power to all of the power outlets in a first area, such as a kitchen, of the premises 101, the power line circuit 118b may provide power to all of the power outlets in a second area, such as a living room, of the premises 101, and so on.

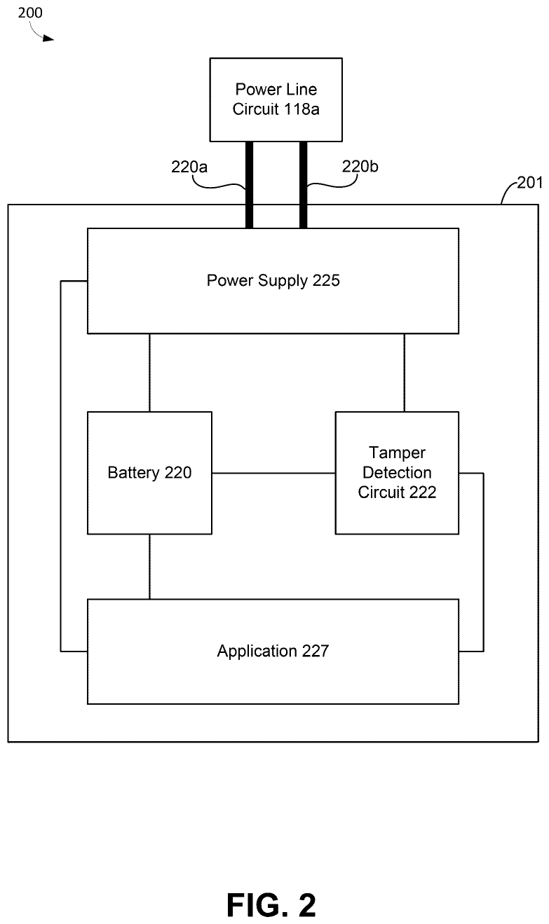

FIG. 2 is an example system 200. The system 300 may comprise a device 201 and the power line circuit 118a. The power line circuit 118a may be located external to the device 201. The device 201 may comprise contacts 220a-b, a power supply 225, a battery 220, a tamper detection circuit 222, and an application 227. The contacts 220a-b may be configured to connect to the power line circuit 118a. For example, the contacts 220a-b may be configured to plug into a power outlet that receives electrical power from the power line circuit 118a. If the contacts 220a-b are plugged into a power outlet that receives electrical power from the power line circuit 118a, the power supply 225 may receive power, such as AC power, from the power line circuit 118a. The power supply 225 may convert the power to direct current (DC) power. The power supply 225 may supply the DC power to the battery 220 and the application 227.

If the device 201 (e.g., the power supply 225) detects that it has stopped receiving power (e.g., AC power) from the power line circuit 118a, the battery 220 may begin supplying power to the application 227 and/or the tamper detection circuit 222. The tamper detection circuit 222 may determine why the device 201 has stopped receiving power from the power line circuit 118a. To determine why the device has stopped receiving power from the power line circuit 118a, the tamper detection circuit 222 may determine a reactance associated with the contacts 220a-b. Determining the reactance associated with the contacts 220a-b may comprise applying a signal via the contact 220a. Based on applying the signal via the contact 220a, the reactance across the contacts 220b may be determined, or vice versa.

If the reactance associated with the contacts 220a-b does not satisfy (e.g., is less than) a threshold, it may be determined that the device 201 is unplugged from the power outlet that receives electrical power from the power line circuit 118a. If the device 201 is unplugged from the power outlet, it may be determined that a security event (e.g., tamper event) has caused the device 201 to stop receiving power from the power line circuit 118a. If a security event (e.g., tamper event) has caused the device 201 to stop receiving power from the power line circuit 118a, then a notification indicative of the security event (e.g., tamper event) may be sent. The notification indicative of the security event may be sent by the application 227. The notification indicative of the security event may be sent to one or more emergency response providers, such as a law enforcement service or a fire department.

If the reactance associated with the contacts 220a-b satisfies (e.g., is greater than or equal to) the threshold, it may be determined that the device 201 is still plugged into the power outlet that receives electrical power from the power line circuit 118a. If the device 201 is still plugged into the power outlet, it may be determined that a power outage associated with the power line circuit 118a has caused the device 201 to stop receiving power from the power line circuit 118a. If a power outage associated with the power line circuit 118a has caused the device 201 to stop receiving power from the power line circuit 118a, then a security event (e.g., tamper event) has not occurred. The device 201 may take no action (e.g., may not send a notification indicative of a security event) if a security event has not occurred.

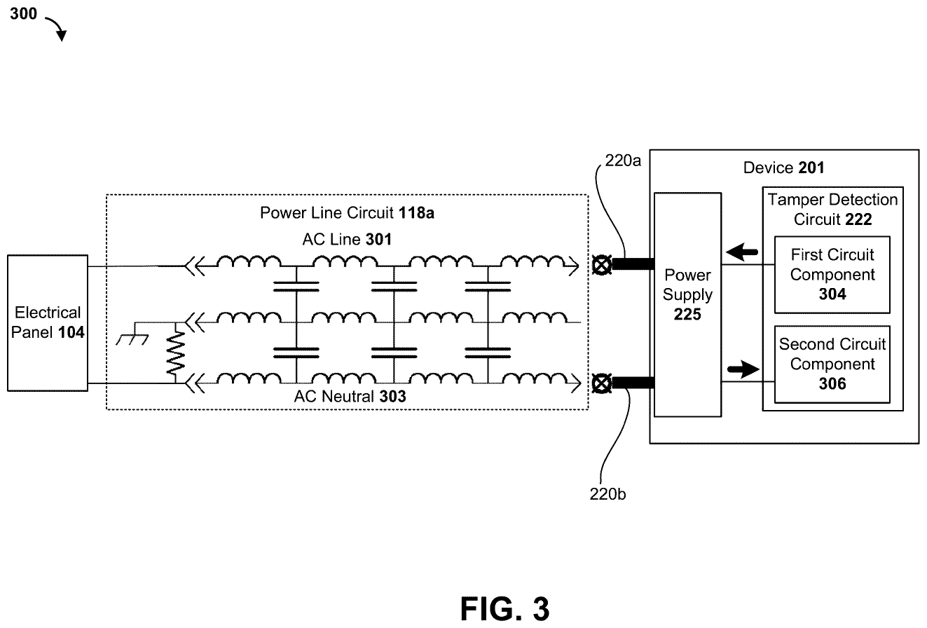

FIG. 3 is an example system 300. The system 300 may comprise the electrical panel 104, the power line circuit 114a, and the device 201. If the device 201 (e.g., the power supply 225) stops receiving power (e.g., AC power) from the power line circuit 118a, the device 201 (e.g., the tamper detection circuit 222) may determine why the device 201 has stopped receiving power from the power line circuit 118a. To determine why the device has stopped receiving power from the power line circuit 118a, a first circuit component 304 (e.g., first circuitry) of the tamper detection circuit 222 may apply a first signal via the contact 220a. The contact 220a may be configured to be connected to an AC line wire 301 of the power line circuit 118a. A second circuit component 306 (e.g., second circuitry), of the tamper detection circuit 222 may receive a second signal via the contact 220b based on (e.g., in response to) the first circuit component 304 applying the first signal via the contact 220a. The contact 220b may be configured to be connected to an AC neutral wire 303 of the power line circuit 118a.

The second circuit component 306 may determine a reactance associated with (e.g., across) the contacts 220a-b. The second circuit component 306 may determine the reactance associated with (e.g., across) the contacts 220a-b based on the second signal. If the reactance associated with the contacts 220a-b does not satisfy (e.g., is less than) a threshold, it may be determined that the device 201 is unplugged from the power outlet that receives electrical power from the power line circuit 118a. The reactance associated with the contacts 220a-b may not satisfy the threshold if the amplitude of the second signal received via the contact 220b is less than the threshold. If the device 201 is unplugged from the power outlet that receives electrical power from the power line circuit 118a, it may be determined that a security event (e.g., tamper event) has caused the device 201 to stop receiving power from the power line circuit 118a.

Conversely, if the reactance associated with the contacts 220a-b satisfies (e.g., is greater than or equal to) the threshold, it may be determined that the device 201 is still plugged into the power outlet that receives electrical power from the power line circuit 118a. The reactance associated with the contacts 220a-b may satisfy the threshold if the amplitude of the second signal received via the contact 220b is greater than or equal to the threshold. If the device 201 is still plugged into the power outlet, it may be determined that a power outage associated with the power line circuit 118a has caused the device 201 to stop receiving power from the power line circuit 118a. If a power outage associated with the power line circuit 118a has caused the device 201 to stop receiving power from the power line circuit 118a, then it may be determined that a security event (e.g., tamper event) has not occurred.

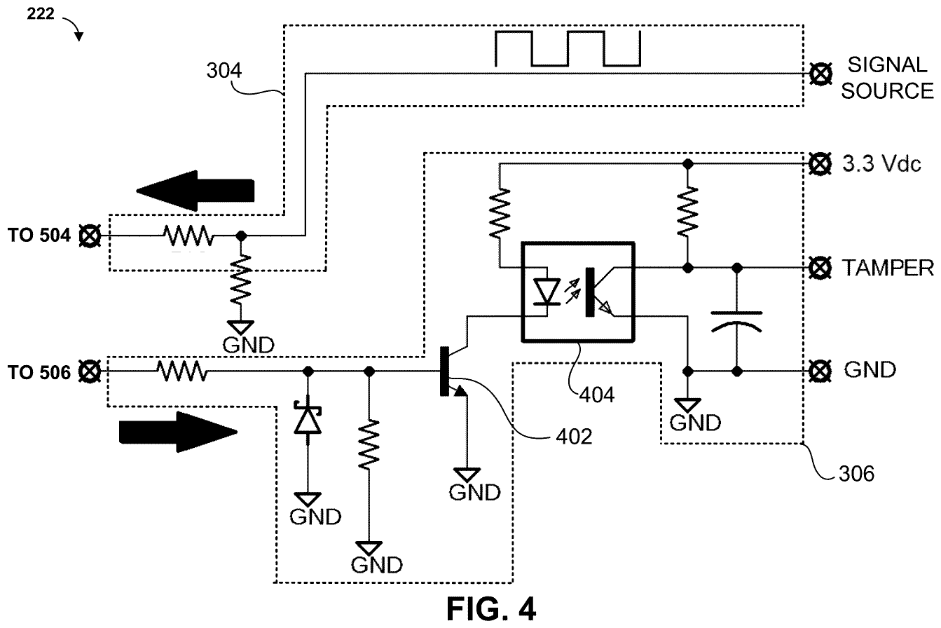

FIG. 4 is an example tamper detection circuit 222. The tamper detection circuit 222 may comprise the first circuit component 304 (e.g., first circuitry) and the second circuit component 306 (e.g., second circuitry). As described above, if the device 201 (e.g., the power supply 225) stops receiving power from the power line circuit 118a, the device 201 (e.g., the tamper detection circuit 222) may determine why the device 201 has stopped receiving power from the power line circuit 118a.

To determine why the device has stopped receiving power from the power line circuit 118a, the first circuit component 304 of the tamper detection circuit 222 may apply a first signal via the contact 220a. The first circuit component 304 may send the first signal. The first signal may be generated, for example, by a processor (e.g., microprocessor). The first signal may be associated with a predetermined frequency, such as 32 kilohertz (KHz). The first circuit component 304 may send the first signal based on (e.g., in response to) receiving the first signal, such as receiving the first signal from the processor. The first circuit component 304 may be configured to send the first signal to the power supply 225 (e.g., to a solid state relay 502 of the power supply 225). The power supply 225 may apply the first signal to the AC line wire 301 of the power line circuit 118a via the contact 220a.

The second circuit component 306 may be configured to determine a reactance across the contacts 220a-b. The second circuit component 306 may receive a second signal based on (e.g., in response to) the first circuit component 304 sending the first signal. The second circuit component 306 may receive the second signal from the power supply 225 (e.g., from a solid state relay 506 of the power supply 225). The second signal may be received from the power supply 225 via the contact 220b. The contact 220b may be configured to be connected to an AC neutral wire 303 of the power line circuit 118a.

The second circuit component 306 may comprise a transistor 402 (e.g., a transistor amplifier) and an opto-isolator 404. The transistor 402 and the opto-isolator 404 may function together to provide a measure of the reactance across the contacts 220a-b. The transistor 402 and the opto-isolator 404 may determine the reactance associated with (e.g., across) the contacts 220a-b based on the second signal. If the amplitude of the second signal is less than a threshold, the transistor 402 may flip (e.g., turn off) and cause the opto-isolator 404 to send a signal indicative of a security event, such as to the processor (e.g., microprocessor) that generated the first signal. If the opto-isolator 404 sends a signal indicative of a security event, a notification indicative of the security event may be sent. For example, the processor may send the notification indicative of the security event based on (e.g., in response to) receiving the signal indicative of a security event. The notification indicative of the security event may be sent to one or more emergency response providers, such as a law enforcement service or a fire department. Conversely, if the amplitude of the second signal is greater than or equal to threshold, this may indicate that a security event has not occurred. Thus, if the amplitude of the second signal is greater than or equal to threshold, the transistor 402 may send a signal indicating that a security event has not occurred, such as such as to the processor (e.g., microprocessor) that generated the first signal.

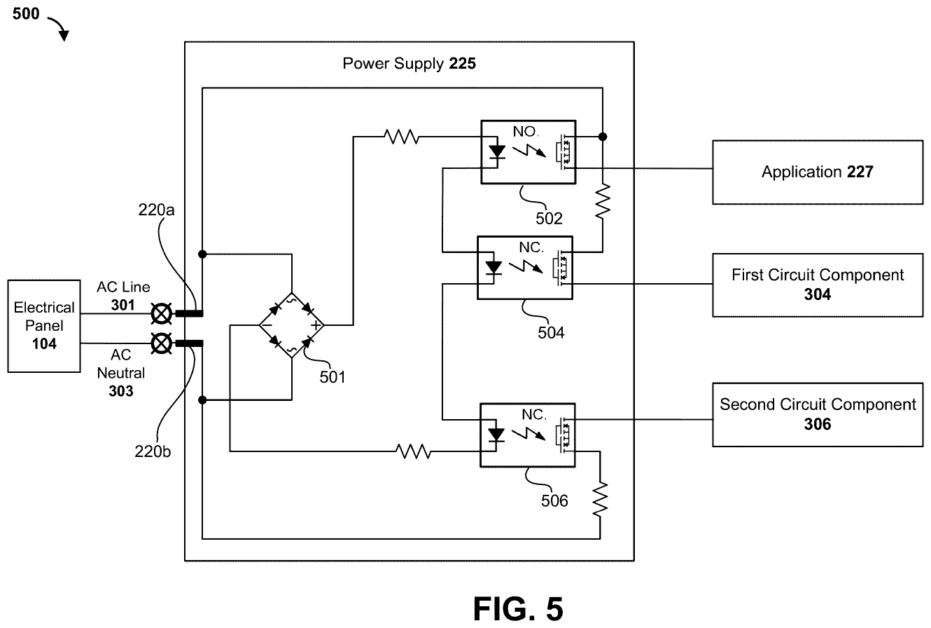

FIG. 5 is an example system 500. The system 500 may comprise the electrical panel 104, the power supply 225, the application 227, the first circuit component 304 (e.g., first circuitry), and the second circuit component 306 (e.g., second circuitry). The power supply 225 may comprise a power circuit including a AC rectifying circuit 501, a first solid state relay 502, a second solid state relay 504, and a third solid state relay 506. If the power circuit of the power supply 225 is receiving power (e.g., AC power) from the electrical panel 104, the first solid state relay 502 may be closed. If the first solid state relay 502 is closed, the application 227 may receive power from the power supply 225. If the power circuit of the power supply 225 is receiving power (e.g., AC power) from the electrical panel 104, the second solid state relay 504 and the third solid state relay 506 may be open. If the second solid state relay 504 and the third solid state relay 506 are open, the tamper detection circuit 222 (e.g., the first circuit component 304 and the second circuit component 306) may be disconnected from the contacts 220a and 220b. If the tamper detection circuit 222 (e.g., the first circuit component 304 and the second circuit component 306) are disconnected from the contacts 220a and 220b, the tamper detection circuit 222 may not attempt to determine a reactance associated with (e.g., across) the contacts 220a-b.

Conversely, if the power circuit of the power supply 225 stops receiving power (e.g., AC power) from the electrical panel 104, the first solid state relay 502 may be open. If the first solid state relay 502 is open, the application 227 may not be connected to the power circuit of the power supply 225. If the power circuit of the power supply 225 stops receiving power (e.g., AC power) from the electrical panel 104, the second solid state relay 504 and the third solid state relay 506 may be closed. If the second solid state relay 504 and the third solid state relay 506 are closed, the tamper detection circuit 222 (e.g., the first circuit component 304 and the second circuit component 306) may be connected to the power circuit of the power supply 225. If the tamper detection circuit 222 is connected to the power circuit of the power supply 225, the tamper detection circuit 222 may determine why the power supply 225 has stopped receiving power from the power line circuit 118a. The tamper detection circuit 222 may determine why the power supply 225 has stopped receiving power from the power line circuit 118a based on determining a reactance associated with (e.g., across) the contacts 220a-b.

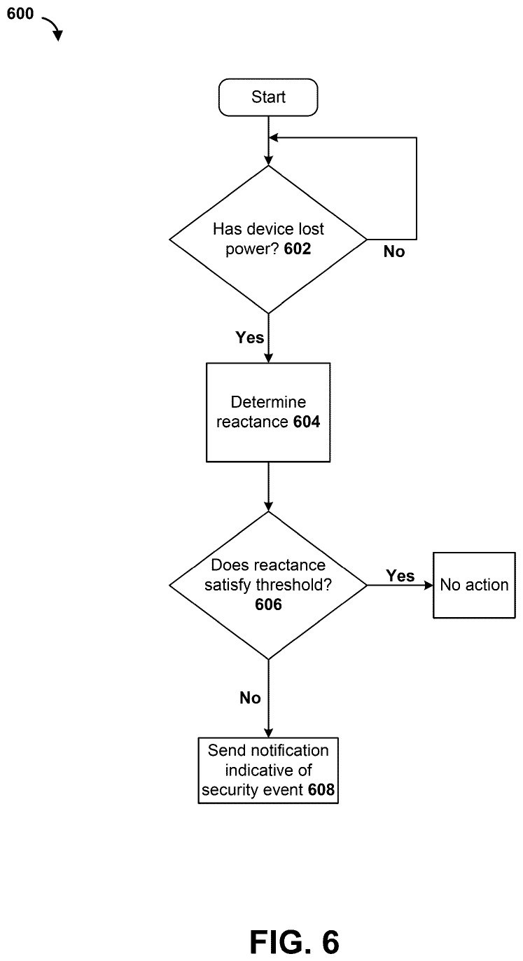

FIG. 6 is an example process 600. A device, such as the device 201, may comprise a pair of contacts, a power supply, a battery, an application, and a tamper detection circuit. The contacts may be configured to connect to a power line circuit. For example, the contacts may be configured to plug into a power outlet that receives electrical power from the power line circuit. If the contacts are plugged into a power outlet that receives electrical power from the power line circuit, the power supply of the device may receive power, such as AC power, from the power line circuit.

At 602, it may be determined if the device has lost power. For example, it may be determined if the power supply of the device has stopped receiving power from the power line circuit. If it is determined the device has not lost power (e.g., the power supply of the device is receiving power from the power line circuit), the process 600 may return to step 602 to continue monitoring for a loss of power. If it is determined the device has lost power (e.g., the power supply of the device is not receiving power from the power line circuit), the process 600 may proceed to step 604 to determine why the device has stopped receiving power from the power line circuit.

At 604, a reactance associated with the pair of contacts may be determined. Determining the reactance associated with the contacts may comprise applying a signal via a first contact of the pair of contacts. A second signal may be received based on (e.g., in response to) applying the first signal via the first contact. The reactance across the pair of contacts may be determined based on the second signal. For example, determining the reactance associated with the at least one contact may comprise determining an amplitude of the second signal.

At 606, it may be determined if the reactance associated with the pair of contacts satisfies a threshold. The reactance associated with the pair of contacts may satisfy the threshold if the amplitude of the second signal is greater than or equal to the threshold. The reactance associated with the pair of contacts may not satisfy the threshold if the amplitude of the second signal is less than threshold.

If the reactance across the pair of contacts satisfies (e.g., is greater than or equal to) the threshold, it may be determined that the device is still plugged into the power outlet that receives electrical power from the power line circuit. If the device is still plugged into the power outlet, it may be determined that a power outage associated with the power line circuit has caused the device 201 to stop receiving power from the power line circuit. If a power outage associated with the power line circuit has caused the device has stopped receiving power from the power line circuit, then a security event (e.g., tamper event) has not occurred.

If the reactance across the pair of contacts does not satisfy (e.g., is less than) a threshold, it may be determined that the device is unplugged from the power outlet that receives electrical power from the power line circuit a. If the device is unplugged from the power outlet, it may be determined that a security event (e.g., tamper event) has caused the device to stop receiving power from the power line circuit. If a security event (e.g., tamper event) has caused the device has stopped receiving power from the power line circuit, then a notification indicative of the security event (e.g., tamper event) may be sent. At 608, a notification indicative of the security event may be sent. The notification indicative of the security event may be sent to one or more emergency response providers, such as a law enforcement service or a fire department.

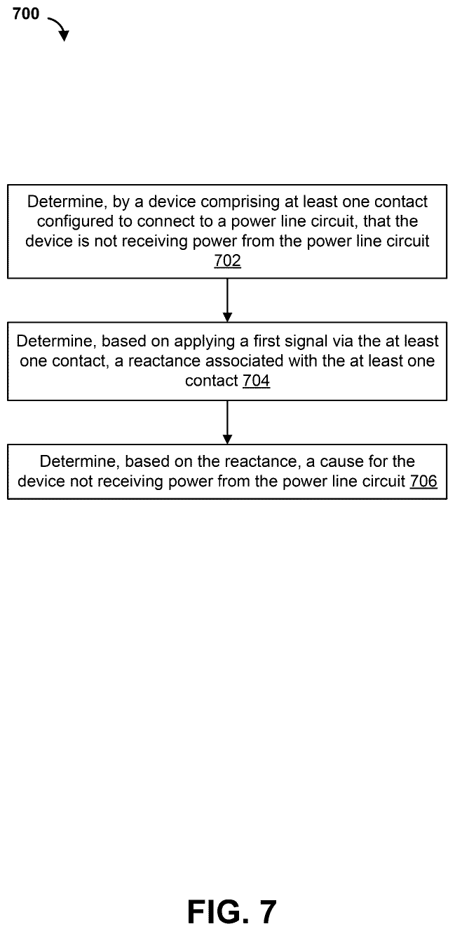

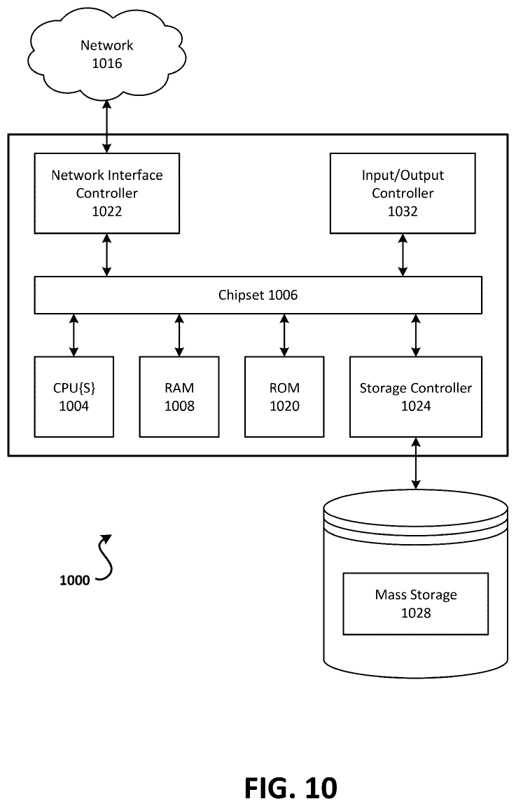

FIG. 7 is an example method 700. The method 700 may comprise a computer implemented method for security event detection. A system and/or computing environment, such as the system 200 of FIG. 2, the system 300 of FIG. 3, and/or the computing environment of FIG. 10, may be configured to perform the method 700. For example, the device 201 of FIGS. 2 and 3 may be configured to perform the method 700.

At 702, it may be determined that a device is not receiving power from a power line circuit. The power line circuit may be located external to the device. The device may comprise at least one contact. The at least one contact may be configured to connect to the power line circuit. For example, the at least one contact may be configured to plug into a power outlet that receives electrical power from the power line circuit.

Based on (e.g., in response to) determining that the device is not receiving power from the power line circuit, a battery of the device may begin supplying power to the components of the device. At 704, a reactance associated with the at least one contact may be determined. The reactance associated with the at least one contact may be determined based on applying a first signal via the at least one contact. Based on applying the first signal via the at least one contact, the reactance across the at least one contact may be determined. A second signal may be received based on (e.g., in response to) applying the first signal via the at least one contact. The reactance associated with the at least one contact may be determined based on the second signal. For example, determining the reactance associated with the at least one contact may comprise determining an amplitude of the second signal.

At 706, a cause for the device not receiving power from the power line circuit may be determined. The cause for the device not receiving power from the power line circuit may be determined based on the reactance associated with the at least one contact. Determining the cause for the device not receiving power from the power line circuit may comprise comparing the reactance associated with the at least one contact to a threshold.

If the reactance associated with the at least one contact does not satisfy (e.g., is less than) the threshold, it may be determined that a security event (e.g., tamper event) has caused the device to stop receiving power from the power line circuit. The reactance associated with the at least one contact may not satisfy the threshold if the amplitude of the second signal is less than the threshold. Determining that a security event has caused the device to stop receiving power from the power line circuit may comprise determining that the at least one contact has been unplugged (e.g., disconnected from) the power line circuit. If a security event has caused the device to stop receiving power from the power line circuit, a notification indicative of the security event may be sent, such as to one or more emergency response providers.

If the reactance associated with the at least one contact satisfies (e.g., is greater than or equal to) the threshold, it may be determined that a security event has not caused the device to stop receiving power from the power line circuit. The reactance associated with the at least one contact may satisfy the threshold if the amplitude of the second signal is greater than or equal to the threshold. Determining that a security event has not caused the device to stop receiving power from the power line circuit may comprise determining that the at least one contact is plugged into (e.g., connected to) the power line circuit. Determining that a security event has not caused the device to stop receiving power from the power line circuit may comprise determining that a power outage associated with the power line circuit has caused the device to stop receiving power from the power line circuit. A notification indicative of a security event may not be sent if a power outage associated with the power line circuit has caused the device to stop receiving power from the power line circuit.

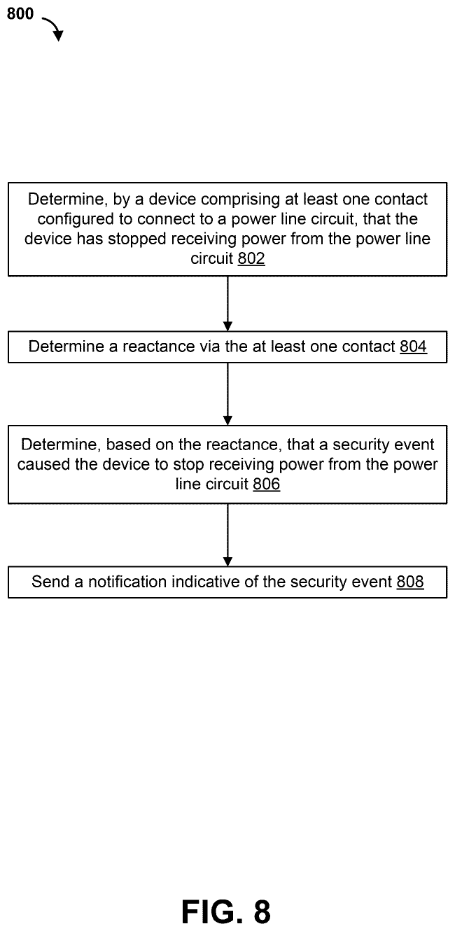

FIG. 8 is an example method 800. The method 800 may comprise a computer implemented method for security event detection. A system and/or computing environment, such as the system 200 of FIG. 2, the system 300 of FIG. 3, and/or the computing environment of FIG. 10, may be configured to perform the method 800. For example, the device 201 of FIGS. 2 and 3 may be configured to perform the method 800.

At 802, it may be determined that a device has stopped receiving power from a power line circuit. The power line circuit may be located external to the device. The device may comprise at least one contact. The at least one contact may be configured to connect to the power line circuit. For example, the at least one contact may be configured to plug into a power outlet that receives electrical power from the power line circuit.

Based on (e.g., in response to) determining that the device has stopped receiving power from the power line circuit, a battery of the device may begin supplying power to the components of the device. At 804, a reactance associated with the at least one contact may be determined. The reactance associated with the at least one contact may be determined based on applying a first signal via the at least one contact. Based on applying the first signal via the at least one contact, the reactance across the at least one contact may be determined. A second signal may be received based on (e.g., in response to) applying the first signal via the at least one contact. The reactance associated with the at least one contact may be determined based on the second signal. For example, determining the reactance associated with the at least one contact may comprise determining an amplitude of the second signal.

At 806, it may be determined that a security event (e.g., tamper event) has caused the device to stop receiving power from the power line circuit. Determining that a security event has caused the device to stop receiving power from the power line circuit may be based on the reactance associated with the at least one contact. The reactance associated with the at least one contact may be compared to a threshold. Determining that a security event has caused the device to stop receiving power from the power line circuit may comprise determining that the reactance associated with the at least one contact does not satisfy (e.g., is less than) the threshold. The reactance associated with the at least one contact may not satisfy the threshold if the amplitude of the second signal is less than the threshold. Determining that a security event has caused the device to stop receiving power from the power line circuit may comprise determining that the at least one contact has been unplugged (e.g., disconnected from) the power line circuit. At 808, a notification may be sent. The notification may be indicative of the security event. The notification may be sent to one or more emergency response providers.

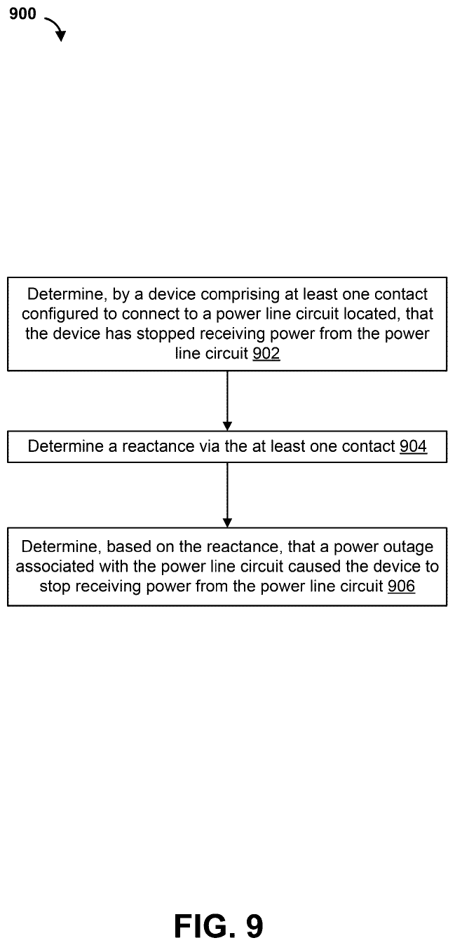

FIG. 9 is an example method 900. The method 900 may comprise a computer implemented method for security event detection. A system and/or computing environment, such as the system 200 of FIG. 2, the system 300 of FIG. 3, and/or the computing environment of FIG. 10, may be configured to perform the method 900. For example, the device 201 of FIGS. 2 and 3 may be configured to perform the method 900.

At 902, it may be determined that a device has stopped receiving power from a power line circuit. The power line circuit may be located external to the device. The device may comprise at least one contact. The at least one contact may be configured to connect to the power line circuit. For example, the at least one contact may be configured to plug into a power outlet that receives electrical power from the power line circuit.

Based on (e.g., in response to) determining that the device has stopped receiving power from the power line circuit, a battery of the device may begin supplying power to the components of the device. At 904, a reactance associated with the at least one contact may be determined. The reactance associated with the at least one contact may be determined based on applying a first signal via the at least one contact. Based on applying the first signal via the at least one contact, the reactance across the at least one contact may be determined. A second signal may be received based on (e.g., in response to) applying the first signal via the at least one contact. The reactance associated with the at least one contact may be determined based on the second signal. For example, determining the reactance associated with the at least one contact may comprise determining an amplitude of the second signal.

At 906, it may be determined that a power outage associated with the power line circuit has caused the device to stop receiving power from the power line circuit. Determining that a power outage associated with the power line circuit has caused the device to stop receiving power from the power line circuit may be based on the reactance associated with the at least one contact. The reactance associated with the at least one contact may be compared to a threshold. Determining that a power outage associated with the power line circuit has caused the device to stop receiving power from the power line circuit may comprise determining that the reactance associated with the at least one contact satisfies (e.g., is greater than or equal to) the threshold. The reactance associated with the at least one contact may satisfy the threshold if the amplitude of the second signal is greater than or equal to the threshold. Determining that a power outage associated with the power line circuit has caused the device to stop receiving power from the power line circuit may comprise determining that a security event has not occurred (e.g., the at least one contact is still plugged into (e.g., connected to) the power line circuit). A signal may be sent. The signal can indicate that a security event has not occurred.

FIG. 10 is example computing device 1000 that may represent any of the various devices or entities shown in FIGS. 2-3, including, for example, the device 201. That is, the computing device 1000 shown in FIG. 10 may be any smartphone, server computer, workstation, access point, router, gateway, tablet computer, laptop computer, notebook computer, desktop computer, personal computer, television, network appliance, PDA, e-reader, user equipment (UE), mobile station, fixed or mobile subscriber unit, pager, wireless sensor, consumer electronics, or other computing device, and may be utilized to execute any aspects of the methods and apparatus described herein, such as to implement any of the apparatus of FIG. 1 or any of the methods described in relation to FIGS. 6-9.

The computing device 1000 may include a baseboard, or “motherboard,” which is a printed circuit board to which a multitude of components or devices may be connected by way of a system bus or other electrical communication paths. One or more central processing units (CPUs or “processors”) 1004 may operate in conjunction with a chipset 1006. The CPU(s) 1004 may be standard programmable processors that perform arithmetic and logical operations necessary for the operation of the computing device 1000.

The CPU(s) 1004 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1004 may be augmented with or replaced by other processing units, such as GPU(s). The GPU(s) may comprise processing units specialized for but not necessarily limited to highly parallel computations, such as graphics and other visualization-related processing.

A chipset 1006 may provide an interface between the CPU(s) 1004 and the remainder of the components and devices on the baseboard. The chipset 1006 may provide an interface to a random-access memory (RAM) 1008 used as the main memory in the computing device 1000. The chipset 1006 may provide an interface to a computer-readable storage medium, such as a read-only memory (ROM) 1020 or non-volatile RAM (NVRAM) (not shown), for storing basic routines that may help to start up the computing device 1000 and to transfer information between the various components and devices. ROM 1020 or NVRAM may also store other software components necessary for the operation of the computing device 1000 in accordance with the aspects described herein.

The computing device 1000 may operate in a networked environment using logical connections to remote computing nodes and computer systems of the system 100. The chipset 1006 may include functionality for providing network connectivity through a network interface controller (NIC) 1022. A NIC 1022 may be capable of connecting the computing device 1000 to other computing nodes over the system 100. It should be appreciated that multiple NICs 1022 may be present in the computing device 1000, connecting the computing device to other types of networks and remote computer systems. The NIC may be configured to implement a wired local area network technology, such as IEEE 802.3 (“Ethernet”) or the like. The NIC may also comprise any suitable wireless network interface controller capable of wirelessly connecting and communicating with other devices or computing nodes on the system 100. For example, the NIC 1022 may operate in accordance with any of a variety of wireless communication protocols, including for example, the IEEE 802.11 (“Wi-Fi”) protocol, the IEEE 802.16 or 802.20 (“WiMAX”) protocols, the IEEE 802.15.4a (“Zigbee”) protocol, the 802.15.3c (“UWB”) protocol, one or more Bluetooth protocols, and/or the like.

The computing device 1000 may be connected to a mass storage device 1028 (e.g., first storage 121) that provides non-volatile storage (i.e., memory) for the computer. The mass storage device 1028 may store system programs, application programs, other program modules, and data, which have been described in greater detail herein. The mass storage device 1028 may be connected to the computing device 1000 through a storage controller 1024 connected to the chipset 1006. The mass storage device 1028 may consist of one or more physical storage units. A storage controller 1024 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1000 may store data on a mass storage device 1028 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1028 is characterized as primary or secondary storage and the like.

For example, the computing device 1000 may store information to the mass storage device 1028 by issuing instructions through a storage controller 1024 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1000 may read information from the mass storage device 1028 by detecting the physical states or characteristics of one or more particular locations within the physical storage units.

In addition to the mass storage device 1028 described herein, the computing device 1000 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1000.

By way of example and not limitation, computer-readable storage media may include volatile and non-volatile, non-transitory computer-readable storage media, and removable and non-removable media implemented in any method or technology. However, as used herein, the term computer-readable storage media does not encompass transitory computer-readable storage media, such as signals. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other non-transitory medium that may be used to store the desired information in a non-transitory fashion.

A mass storage device, such as the mass storage device 1028 depicted in FIG. 10, may store an operating system utilized to control the operation of the computing device 1000. The operating system may comprise a version of the LINUX operating system. The operating system may comprise a version of the WINDOWS SERVER operating system from the MICROSOFT Corporation. According to additional aspects, the operating system may comprise a version of the UNIX operating system. Various mobile phone operating systems, such as IOS and ANDROID, may also be utilized. It should be appreciated that other operating systems may also be utilized. The mass storage device 1028 may store other system or application programs and data utilized by the computing device 1000.

The mass storage device 1028 or other computer-readable storage media may also be encoded with computer-executable instructions, which, when loaded into the computing device 1000, transforms the computing device from a general-purpose computing system into a special-purpose computer capable of implementing the aspects described herein. These computer-executable instructions transform the computing device 1000 by specifying how the CPU(s) 1004 transition between states, as described herein. The computing device 1000 may have access to computer-readable storage media storing computer-executable instructions, which, when executed by the computing device 1000, may perform the methods described in relation to FIGS. 6-9.

A computing device, such as the computing device 1000 depicted in FIG. 10, may also include an input/output controller 1032 for receiving and processing input from a number of input devices, such as a keyboard, a mouse, a touchpad, a touch screen, an electronic stylus, or other type of input device. Similarly, an input/output controller 1032 may provide output to a display, such as a computer monitor, a flat-panel display, a digital projector, a printer, a plotter, or other type of output device. It will be appreciated that the computing device 1000 may not include all of the components shown in FIG. 10, may include other components that are not explicitly shown in FIG. 10, or may utilize an architecture completely different than that shown in FIG. 10.

As described herein, a computing device may be a physical computing device, such as the computing device 1000 of FIG. 10. A computing device may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems described herein are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes¬ from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey data indicating a preferred or ideal embodiment. “Such as” is not used in a restrictive sense, but for explanatory purposes.

Components and devices are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable instructions (e.g., computer software or program code) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described above with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are shown as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the shown computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method comprising:
determining, by a device comprising at least one contact configured to connect to a power line circuit located external to the device, that the device is not receiving power from the power line circuit;
determining, based on applying a first signal via the at least one contact, a reactance associated with the at least one contact; and
determining, based on the reactance, a cause for the device not receiving power from the power line circuit.

2. The method of claim 1, wherein determining the cause for the device not receiving power from the power line circuit comprises determining, based on the reactance not satisfying a threshold, that a security event associated with the device caused the device to stop receiving power from the power line circuit.

3. The method of claim 2, wherein determining that the security event associated with the device caused the device to stop receiving power from the power line circuit comprises determining that the at least one contact is not connected to the power line circuit.

4. The method of claim 2, further comprising sending, to at least one computing device, a notification indicative of the security event.

5. The method of claim 1, wherein determining the cause for the device not receiving power from the power line circuit comprises determining, based on the reactance satisfying a threshold, that a power outage associated with the power line circuit caused the device to stop receiving power from the power line circuit.

6. The method of claim 1, wherein determining the reactance associated with the at least one contact comprises:
receiving, based on applying the first signal via the at least one contact, a second signal; and
determining the reactance based on the second signal.

7. The method of claim 6, wherein determining the reactance based on the second signal comprises determining an amplitude of the second signal.

8. The method of claim 1, wherein the power line circuit comprises an alternating current (AC) power line circuit.

9. The method of claim 1, wherein the device comprises a battery.

10. A method comprising:
determining, by a device comprising at least one contact configured to connect to a power line circuit located external to the device, that the device has stopped receiving power from the power line circuit;
determining a reactance via the at least one contact;
determining, based on the reactance failing to satisfy a threshold, that a security event caused the device to stop receiving power from the power line circuit; and
sending, to at least one computing device, a notification indicative of the security event.

11. The method of claim 10, wherein determining that the security event caused the device to stop receiving power from the power line circuit comprises determining that the at least one contact is not connected to the power line circuit.

12. The method of claim 10, wherein determining the reactance associated with the power line circuit comprises:
receiving, based on applying a first signal via the at least one contact, a second signal; and
determining the reactance based on the second signal.

13. The method of claim 12, wherein determining the reactance based on the second signal comprises determining an amplitude of the second signal, wherein the reactance fails to satisfy the threshold based on the amplitude being less than or equal to the threshold.

14. The method of claim 10, wherein the power line circuit is an alternating current (AC) power line circuit.

15. A method comprising:
determining, by a device comprising at least one contact configured to connect to a power line circuit located external to the device, that the device has stopped receiving power from the power line circuit;
determining a reactance via the at least one contact; and
determining, based on the reactance satisfying a threshold, that a power outage associated with the power line circuit caused the device to stop receiving power from the power line circuit.

16. The method of claim 15, wherein determining that the power outage associated with the power line circuit caused the device to stop receiving power from the power line circuit comprises determining that the at least one contact is connected to the power line circuit.

17. The method of claim 15, wherein determining that the power outage associated with the power line circuit caused the device to stop receiving power from the power line circuit comprises determining that the device is not associated with a security event.

18. The method of claim 15, wherein determining the reactance associated with the power line circuit comprises:
receiving, based on applying a first signal via the at least one contact, a second signal; and
determining the reactance based on the second signal.

19. The method of claim 18, wherein determining the reactance based on the second signal comprises determining an amplitude of the second signal, wherein the reactance satisfies the threshold based on the amplitude being greater than the threshold.

20. The method of claim 9, wherein the power line circuit is an alternating current (AC) power line circuit.
